(19) United States
(12) Patent Application Publication
(10) Pub. No.: US 2006/0067263 A1
(43) Pub. Date: Mar. 30, 2006

(54) Techniques to manage multiple receivers

(76) Inventors: Qinghua Li, Sunnyvale, CA (US); Xintian E. Lin, Palo Alto, CA (US); Jian Lin, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/957,274

(22) Filed: Sep. 30, 2004

(51) Int. Cl. H04J 3/08; H04B 7/14; H04J 1/10

(52) U.S. Cl. 370/315

(57) ABSTRACT

Method and apparatus to manage multiple receivers for a wireless device are described.

### BACKGROUND

In a wireless communication system, wireless communication devices may transmit and/or receive radio frequency (RF) signals through one or more antennas. Some wireless communication devices may include multiple antennas. The wireless communication devices with multiple antennas may include a multiple-input-multiple-output (MIMO) modulation and/or coding system to control receiving and transmitting of RF signals through the multiple antennas. Techniques to improve control and management of a MIMO system may improve overall system performance.

### BRIEF DESCRIPTION OF THE DRAWINGS

FIG. 1 illustrates a block diagram of a system 100.

FIG. 2 illustrates a partial block diagram of a node 200.

FIG. 3 illustrates a timing diagram 300.

FIG. 4 illustrates a frame 400.

FIG. 5 illustrates a frame 500.

FIG. 6 illustrates a frame 600.

FIG. 7 illustrates a programming logic 700.

### DETAILED DESCRIPTION

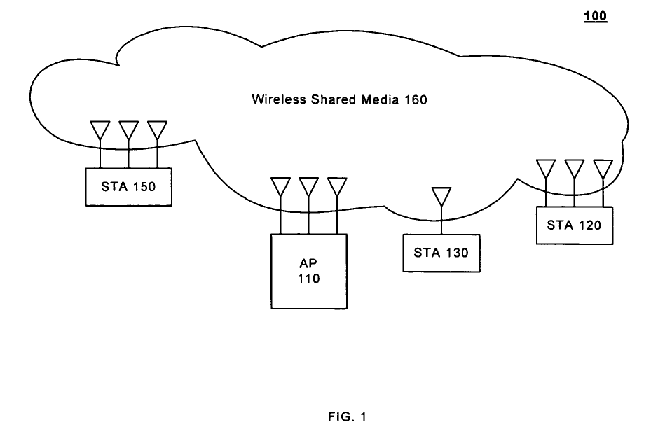

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a computer, server, workstation, laptop, ultra-laptop, handheld computer, telephone, cellular telephone, personal digital assistant (PDA), router, switch, bridge, hub, gateway, wireless access point (WAP), and so forth. The unique address may comprise, for example, a network address such as an Internet Protocol (IP) address, a device address such as a Media Access Control (MAC) address, and so forth. The embodiments are not limited in this context.

The nodes of system 100 may be arranged to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth. For example, system 100 may operate in accordance with the IEEE 802.11 wireless local area network (WLAN) series of standard protocols, such as the IEEE 802.11n, 2004 proposed standard (“802.11n Proposed Standard”). In another example, system 100 may operate in accordance with the IEEE 802.16 and 802.20 series of standard protocols. The embodiments are not limited in this context.

Referring again to FIG. 1, system 100 may comprise a wireless communication system operating in accordance with, for example, the IEEE 802.11 series of protocols. System 100 may include an access point (AP) 110, a station (STA) 120, a STA 130, and a STA 150, all arranged to communicate information signals using wireless shared media 160. Information signals may include any type of signal encoded with information, such as media and/or control information. Although FIG. 1 is shown with a limited number of nodes in a certain topology, it may be appreciated that system 100 may include more or less nodes in any type of topology as desired for a given implementation. The embodiments are not limited in this context.

In one embodiment, system 100 may comprise AP 110. AP 110 may comprise a wireless access point for a network, such as a WLAN. In one embodiment, for example, AP 110 may be implemented as a high throughput (HT) wireless device arranged to operate in accordance with the IEEE-802.11n Proposed Standard. AP 110 may include a MIMO system having multiple transmitters/receivers (“transceivers”) and multiple antennas. The embodiments are not limited in this context.

In one embodiment, system 100 may comprise STA 120, STA 130 and STA 150. STA 120, 130 and 150 may each be implemented as, for example, a wireless communication device, such as mobile or cellular telephone, a computer or laptop equipped with a wireless access card, a handheld device such as a wireless PDA, an integrated cellular telephone/PDA, and so forth. The embodiments are not limited in this context.

In one embodiment, for example, STA 120 and STA 150 may be implemented as HT wireless devices arranged to operate in accordance with the IEEE-802.11n Proposed Standard. STA 120 and STA 150 may each include a MIMO system having at least two transceivers and two antennas. The MIMO system, however, may have any number of transceivers and antennas, and the embodiments are not limited in this context.

System 100 may also include one or more “legacy” stations, such as STA 130. Legacy stations may include a single receiver, a single transmitter, and at least one antenna. Legacy stations, however, typically do not include MIMO system, although the embodiments are not limited in this context.

In general operation, the nodes of system 100 may operate in multiple operating modes. For example, STA 120, STA 150 and AP 110 may operate in at least one of the following operating modes: a single-input-single-output (SISO) mode, a multiple-input-single-input (MISO) mode, a single-input-multiple-output (SIMO) mode, and/or in a MIMO mode. In a SISO operating mode, a single transmitter and a single receiver may be used to communicate information signals over a wireless shared medium 160. In a MISO operating mode, two or more transmitters may transmit information signals over wireless shared media 160, and information signals may be received from wireless shared media 160 by a single receiver of a MIMO system. In a SIMO operating mode, one transmitter and two or more receivers may be used to communicate information signals over wireless shared media. In a MIMO operating mode, two or more transmitters and two or more receivers may be used to communicate information signals over wireless shared media 160.

One problem associated with wireless communication devices using carrier sense multiple access/collision detection (CSMA/CD) techniques (e.g., 802.11) is power consumption. For example, a station in idle mode waiting for incoming signals may consume approximately 60% of its battery energy. This inefficient use of energy may be exacerbated by MIMO devices, since more than one antenna may be turned on for reception. The power consumed by low noise amplifiers and analog-to-digital converters may be multiplied by the number of antennas. As a result, a station may use less than 20% of its battery energy for communicating actual traffic.

Some embodiments may solve this and other problems. In one embodiment, for example, AP 110, STA 120 and/or STA 150 may be initially set to operate in a SISO or a MISO operating mode, and may be subsequently switched to a MIMO operating mode. For example, AP 110 operating in a MISO or a SISO operating mode may send a request over wireless shared media 160 to switch STA 120 and STA 150 to a SIMO or MIMO operating mode, if desired. STA 120 and STA 150 may acknowledge the request and may enable an operation of desired number of receivers and transmitters of the MIMO receivers-transmitters system. In this manner, power consumption for STA 120 and STA 150 may be reduced, thereby extending the battery life for STA 120 and STA 150.

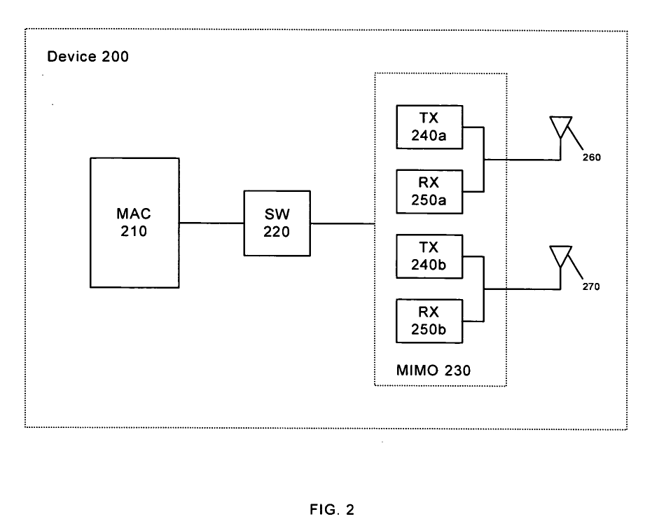

FIG. 2 illustrates a partial block diagram of a node 200. Node 200 may be implemented as part of AP 110, STA 120 and/or STA 150 as described with reference to FIG. 1. As shown in FIG. 2, node 200 may comprise multiple elements, such as processor 210, switch (SW) 220, and a transceiver array 230. Some elements may be implemented using, for example, one or more circuits, components, registers, processors, software subroutines, or any combination thereof. Although FIG. 2 shows a limited number of elements, it can be appreciated that more or less elements may be used in node 200 as desired for a given implementation. The embodiments are not limited in this context.

In one embodiment, node 200 may include a transceiver array 230. Transceiver array 230 may be implemented as, for example, a MIMO system. MIMO system 230 may include two transmitters 240a and 240b, and two receivers 250a and 250b. Although MIMO system 230 is shown with a limited number of transmitters and receivers, it may be appreciated that MIMO system 230 may include any desired number of transmitters and receivers. The embodiments are not limited in this context.

In one embodiment, transmitters 240a-b and receivers 250a-b of MIMO system 230 may be implemented as Orthogonal Frequency Division Multiplexing (OFDM) transmitters and receivers. Transmitters 240a-b and receivers 250a-b may communicate data frames with other wireless devices. For example, when implemented as part of AP 110, transmitters 240a-b and receivers 250a-b may communicate data frames with STA 120, STA 130 and STA 150. When implemented as part of STA 120 and/or STA 150, transmitters 240a-b and receivers 250a-b may communicate data frames with AP 110. The data frames may be modulated in accordance with a number of modulation schemes, to include Binary Phase Shift Keying (BPSK), Quadrature Phase-Shift Keying (QPSK), Quadrature Amplitude Modulation (QAM), 16-QAM, 64-QAM, and so forth. The embodiments are not limited in this context.

In one embodiment, transmitter 240a and receiver 250a may be operably coupled to an antenna 260, and transmitter 240b and receiver 250b may be operably coupled to antenna 270. Examples for antenna 260 and/or antenna 270 may include an internal antenna, an omni-directional antenna, a monopole antenna, a dipole antenna, an end fed antenna or a circularly polarized antenna, a micro-strip antenna, a diversity antenna, a dual antenna, an antenna array, and so forth. The embodiments are not limited in this context.

In one embodiment, node 200 may include a processor 210. Processor 210 may be implemented as, for example, a media access control (MAC) processor. MAC 210 may be arranged to receive a physical layer convergence procedure (PLCP) protocol data unit (PPDU). MAC 210 may output a receiver control signal in response to the received PPDU. The receiver control signal may cause MIMO system 230 to switch between a first operating mode and a second operating mode in response to the receiver control signal. This may be accomplished using switch 220, for example. An example of the first operating mode may include a SIMO operating mode and a MIMO operating mode. Examples of the second operating mode may include a SISO operating mode and a MISO operating mode. The embodiments are not limited in this context.

When implemented as part of an AP such as AP 110, node 200 may initiate a request to switch a station such as STA 120 and/or STA 150 from a SISO or MISO operating mode into a SIMO or MIMO operating mode. Node 200 may operate in either SISO or MISO operating mode to send the request. When implemented as part of a station such as STA 120 and/or STA 150, node 200 may receive the request and switch MIMO system 230 from a SISO or MISO operating mode into a MIMO operating mode. This may be accomplished by enabling two or more receivers from MIMO system 230. The term “enabling” or “enable” or its variations as used herein may refer to turning on or providing power to a transceiver to place it in an operating state.

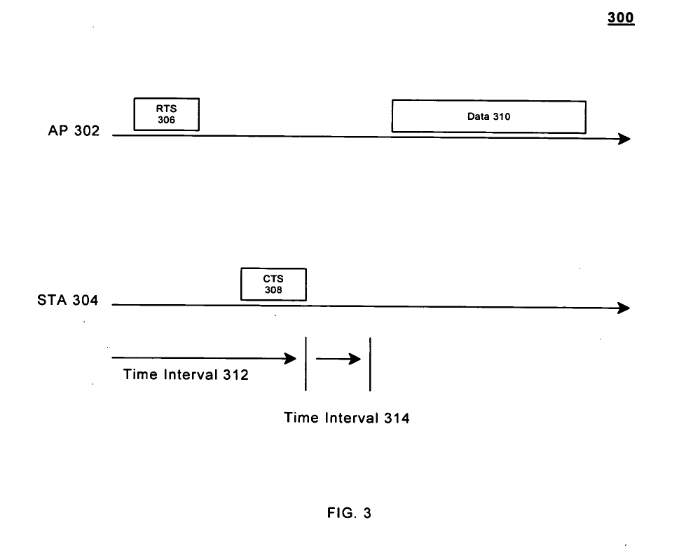

In one embodiment, the request may be implemented using a Request-To-Send (RTS) and Clear-To-Send (CTS) network access technique. The RTS/CTS network access technique may be described in more detail with reference to FIG. 3.

FIG. 3 illustrates a timing diagram 300. Timing diagram 300 may illustrate the communication of information between an AP 302 and STA 304. AP 302 may be representative of, for example, AP 110. STA 304 may be representative of, for example, STA 120 and STA 150. Assume STA 304 is initially arranged to operate in a SISO or MISO operating mode. AP 302 may send a RTS message 306 to STA 304 during a first time interval 312. STA 304 may receive RTS message 306, and may send a CTS message 308 in response to RTS message 306 during first time interval 312.

After STA 304 receives RTS message 306, STA 304 may also begin to turn on additional receiver chains in anticipation of receiving data 310. The additional receiver chains will begin the power up process during time interval 314. When turning on the additional receiver chains, the supply voltage of the VOC and PLL may vary with the rush current consumed by the other receiver chains. Consequently, the receiver chain may lose frequency synchronization for a transition period of approximately 4-10 micro-seconds. Accordingly, AP 302 may be arranged to begin transmitting data 310 after time interval 314 to ensure that all the receiver chains are properly operating, and therefore capable of receiving transmitted data 310.

In addition to RTS 306, STA 304 may also be arranged to turn on additional receiver chains in response to other messages. For example, control frames other than RTS may be used for medium access control in order to reserve the medium for the subsequent data frame. STA 304 may turn on additional receiver chains if needed according to the control frame before the data frame. In another example, STA 304 may fail to receive RTS 306 and begin receiving data 310. STA 304 may begin to turn on additional receiver chains in response to data 310. Although STA 304 may not be prepared to receive data 310 due to latencies in powering up the additional receiver chains, STA 304 may be ready to receive a resend of data 310 sent using an error correction scheme, for example. The embodiments are not limited in this context.

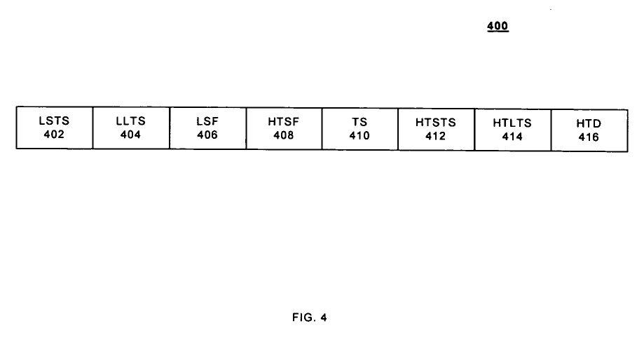

In addition to RTS 306 and data 310, STA 304 may turn on additional receiver chains in response to a PLCP header and/or PPDU. The PLCP may define a set of operations to transform each 802.11 frame that a station or AP is to send into a PPDU. AP 302 may create a PPDU modified in a way to instruct STA 304 to turn on additional receiver chains to operate in a SIMO or MIMO operating mode. STA 304 may receive a PPDU, and begin to turn on the additional receiver chains in response to the PPDU. Examples of various PPDU appropriate for use in instructing STA 304 to switch to a MIMO operating mode may be described in more detail with reference to FIGS. 4-6.

FIG. 4 illustrates a frame 400. Frame 400 may be representative of a first PPDU used to instruct an AP or station to switch to a SIMO or MIMO operating mode. As shown in FIG. 4, frame 400 may include a legacy portion having a legacy short training symbols (LSTS) field 402, a legacy long training symbols (LLTS) field 404, a legacy signal field (LSF) 406. Frame 400 may also include a HT portion having a HT signal field (HTSF) 408, a HT short training symbols (HTSTS) field 412, a HT long training symbols (HTLTS) field 414, and a HT data (HTD) field 416. It may be appreciated that although frame 400 shows a limited number of fields, frame 400 may also include more or less fields and still fall within the scope of the embodiments.

In one embodiment, frame 400 may further include a transition symbols (TS) field 410 inserted before HTSTS 412. TS 410 may be used to insert a transition period in an 802.11n training sequence. The transition period may allow a receiver to turn on other receiver chains for training. TS 410 may be used to communicate one or more transition symbols. The total duration of the transition symbols should be slightly longer than the time needed for the transition period to turn on the additional receiver chains. The transition symbols may be implemented as, for example, legacy short preambles. The legacy short preambles may have a low peak to average ratio and therefore can be detected by legacy devices (e.g., STA 130) with high sensitivity. As a result, the legacy short preambles may prevent other devices from transmitting thereby reducing the possibility for collisions. For example, assume the transition period may comprise 4-10 micro-seconds. In this case, 10 legacy short preambles, each taking approximately 0.8 micro-second, could be employed as transition symbols.

The transition symbols may be transmitted by multiple antennas using, for example, tone interleaving or cyclic delay diversity techniques. This may improve the detection rate, and may also assist in setting the automatic gain control (AGC) for the other receiver chains. The signals among the various transmit/receive antenna pairs may be superimposed. The superimposed signals may indicate the average receive power level. The average receive power level may be used for the AGC settings.

The insertion of the transition symbols for TS 410 of frame 400 may vary. For example, the insertion of the transition symbols can be negotiated between AP 302 and STA 304 in accordance with MAC operations. The insertion of TS 410 may not necessarily be needed if the receiver can turn on the additional receiver chains during/between HTSTS 412 and HTLTS 414.

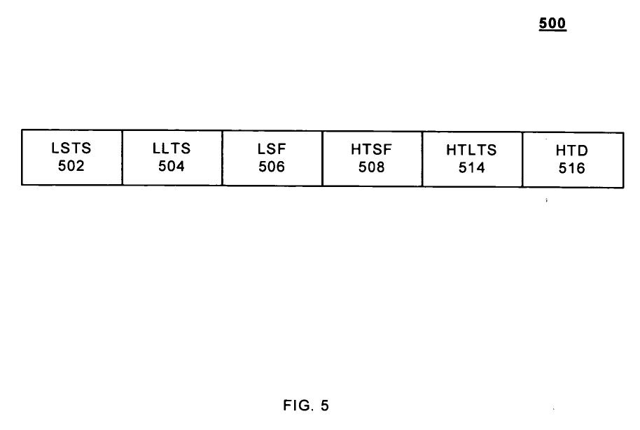

FIG. 5 illustrates a frame 500. Frame 500 may be representative of a second PPDU used to instruct an AP or station to switch to a SIMO or MIMO operating mode. Frame 500 may be used in alone, or in conjunction with frame 400, to further reduce power consumption at a receiving station. As shown in FIG. 5, frame 500 may include a legacy portion having a LSTS field 502, a LLTS field 504, a LSF 506. Frame 500 may also include a HT portion having a HTSF 508, a HTLTS field 514, and a HTD field 516. It may be appreciated that although frame 500 shows a limited number of fields, frame 500 may also include more or less fields and still fall within the scope of the embodiments.

Frame 500 may be used to add a physical layer address or identifier to an 802.11n PLCP header. More particularly, HTSF 508 of frame 500 may be modified to include a physical layer address or identifier for a receiving station. The physical layer address or identifier may be used to reduce decoding power spent on traffic not explicitly addressed to the receiving station. For example, a receiving station such as STA 304 may receive frame 500 and decode HTSF 508 to retrieve the physical layer address or identifier. STA 304 may drop the packet if frame 500 is not addressed to STA 304 or a group including STA 304 (e.g., broadcast or multicast address), thereby reducing or eliminating the need to use power to decode the remainder of frame 500.

Modifying HTSF 508 to include a physical layer address or identifier may be accomplished in a number of different ways. For example, HTSF 508 may be modified to include a complete address format comprising both a source address and destination address for each packet. In an 802.11 MAC, four addresses are typically employed. This may, however, add a significant amount of overhead in the physical layer and thereby potentially reduce throughput. HTSF 508 may therefore be modified to include only the destination address to lower the associated overhead with a packet. The embodiments are not limited in this context.

In one embodiment, HTSF 508 may be further modified to include only a portion of the destination address. The destination address does not necessarily need to uniquely identify the individual receiving station or group of stations, since it may not be necessary to exclude all traffic received by the individual receiving station or group of stations to gain a desired level of power efficiency. For example, if an address with two bits is randomly assigned to each station, each station could exclude up to three quarters of the traffic and reduce the demodulation/decoding power consumption to one quarter of the original average. Additional bits may be used as needed for a given system or subsystem. To reduce the complexity in designing the physical layer address, it may be desirable to use the last two bits of the current destination address assigned to a receiving station by the 802.11 MAC protocol. For example, each receiver may discontinue HT training and HT payload decoding if the physical address in HTSF 508 does not match the last two bits of the receiving stations assigned MAC address or the last bits of any broadcast address. The embodiments are not limited in this context.

By modifying HTSF 508 to include a physical layer address or identifier for the receiving station may also improve the efficiency of collision avoidance techniques for the receiving station. LSF field 506 may include a duration field having a duration field value. Consequently, a receiving station such as STA 304 may know the transmitting packet duration after it decodes the duration field. STA 304 may wait for a period of time equal to at least the duration field value before it contends for the medium.

By way of contrast, 802.11a/b/g and 802.11n systems may use a network allocation vector (NAV) to implement collision avoidance. The NAV may be embedded in the payload of a received PPDU. A receiving station, however, may not be able to decode the payload portion of a received packet due to differences in supported data rates, modulation modes, beam formed radiation patterns, coding modes, and so forth. Therefore, the network allocation vector (NAV) contained in the payload may not be read by each device. Consequently, the collision avoidance techniques provided by NAV is not always available and may be potentially unreliable. Further, the decoding of a MIMO modulated payload may be very power intensive, therefore making a NAV relatively expensive to implement in terms of power consumption.

In addition to using a PPDU such as frame 500, alternate embodiments may use other control frames having the physical layer address or identifier to potentially save power at a receiving station. For example, any conventional control frame may be used to save power if it includes, or is modified to include, the following information: (1) a transmission period for a subsequent data frame(s); and (2) a physical layer address or identifier for the subsequent data frame(s). Examples of control frames may include an RTS, CTS, and so forth. If the control frame is received before the subsequent data frame, the receiver may use the information from the control frame to determine whether to drop the subsequent data frame. As a result, the receiver can reduce or avoid expending power on the demodulation/decoding of any coming data frames that are not addressed to the receiver.

FIG. 3 may be used to provide an example. AP 302 may send RTS 306 to STA 304. Assume RTS 306 includes a data frame transmission period and address. STA 304 may receive RTS 306, and send CTS 308 in response to signal AP 302 to begin sending data frame 310. CTS 308 includes the data frame transmission period and the address of AP 302. STA 304 may also begin initiating additional receiver chains to switch to a SIMO or MIMO operating mode to receive data frame 310. STA 304 may retrieve the data frame transmission period and address for data frame 310 from RTS 306. Stations in the same network other than STA 304, however, may decide to avoid the demodulating/decoding of data frame 310 after receiving information in RTS 306 or CTS 308. Similarly, when STA 304 begins receiving data frame 310, it can match the data frame transmission period and address information retrieved from RTS 306 with the information in data frame 310. If there is no match, then STA 304 can stop the demodulating/decoding of data frame 310, thereby further saving power at STA 304.

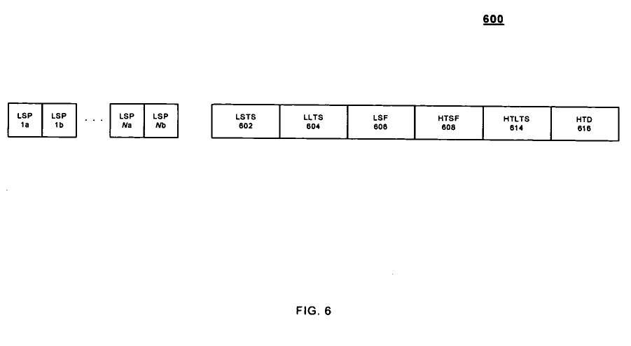

FIG. 6 illustrates a frame 600. Frame 600 may be representative of a third PPDU used to instruct an AP or station to switch to a SIMO or MIMO operating mode. Frame 600 may be used alone in lieu of frame 400, or in conjunction with frame 500, to further reduce power consumption at a receiving station. As shown in FIG. 6, frame 600 may include a legacy portion having a LSTS field 602, a LLTS field 604, a LSF 606. Frame 600 may also include a HT portion having a HTSF 608, a HTLTS field 614, and a HTD field 616. It may be appreciated that although frame 600 shows a limited number of fields, frame 600 may also include more or less fields and still fall within the scope of the embodiments.

Frame 600 may also include a sequence of special preambles before LSTS field 602. The sequence of special preambles may include legacy short preambles having a first phase followed by legacy short preambles with a second phase. The sequence of special preambles may be arranged to be detectable by legacy devices (e.g., STA 130). The legacy devices may enter a state of subsequent preamble searching, and therefore may be prevented from performing channel contention with other stations in the system.

More particularly, frame 600 may include a sequence of special preambles, such as multiple legacy short preambles (LSP) 1a-b to LSP Na-b, where N is an integer. The sequence of special preambles should be different from the preambles used for LSTS 602. In this manner, the difference may notify the receiver to begin turning on additional receiver chains for HT training. Accordingly, frame 600 may include multiple legacy short preambles (LSP), with every pair of LSP having a first phase to be followed by another pair of LSP having a second phase. For example, LSP 1a-b may have a first phase, LSP 2a-b may have a second phase, LSP 3a-b may have the first phase, LSP 4a-b may have the second phase, and so forth all the way through LSP Na-b. The receiving station may detect the phase change between the alternating pairs, and turn on the other receiver chains.

Frame 600 may offer several advantages. For example, the sequence of special preambles may be detected by legacy devices so that the devices enter a state of searching for subsequent preambles, and therefore do not contend for the medium for the duration of the sequence. In another example, the sequence of special preambles may have low peak to average ratio and therefore may have high detection sensitivity. The detection may therefore be more reliable than a clear channel assessment (CCA), for example, due to the dispreading gain of preamble detection.

The sequence duration may vary according to a given implementation. In general, the sequence duration should be slightly longer than the off/on transition period for the receiving chains. In one embodiment, for example, the sequence duration may be approximately 10-16 micro-seconds. The embodiments are not limited in this context.

In one embodiment, a gap without any power transmission may be inserted between the added sequence of special symbols and the legacy short preambles of LSTS field 602. The gap may ensure that the legacy short preambles of LSTS field 602 may be properly detected without confusion induced by the phase shifts of the sequence of special preambles. In one embodiment, for example, the gap may be set in accordance with the CCA time of a legacy device, such as 4 micro-seconds or less. The embodiments are not limited in this context.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

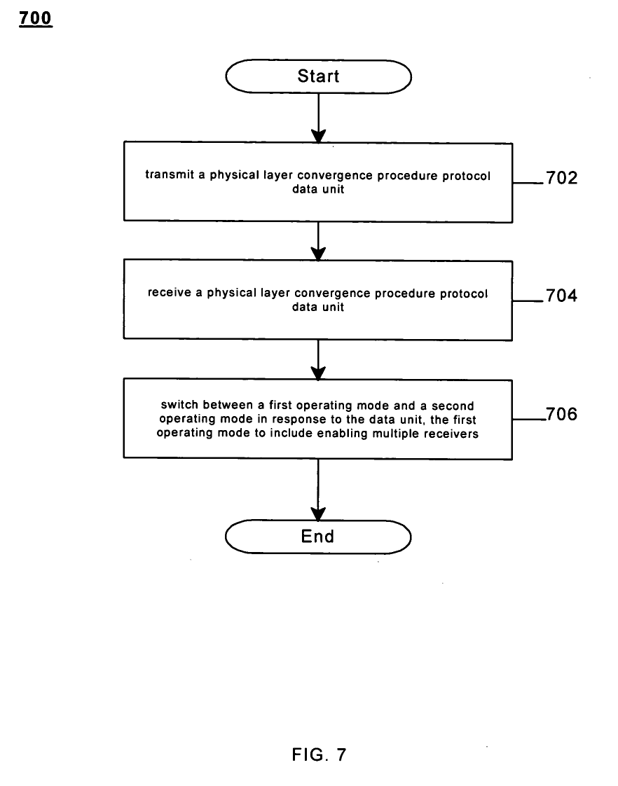

FIG. 7 illustrates a programming logic 700. Programming logic 700 may be representative of the operations executed by one or more systems described herein, such as system 100 and/or node 200. As shown in programming logic 700, a PPDU may be transmitted at block 702. The PPDU may be transmitted in, for example, a SISO operating mode or MISO operating mode. The PPDU may be received at block 704. Switching between a first operating mode and a second operating mode may occur in response to the PPDU. An example of the first operating mode may include enabling a determined number of receivers, such as in a SIMO or MIMO operating mode. Examples for the second operating mode may include a SISO operating mode and a MISO operating mode.

In one embodiment, the PPDU may include one or more transition symbols. A determination for an average receive power level may be made from the transition symbols. An AGC for a receiver may be set using the average receive power level.

It should be understood that the embodiments may be used in a variety of applications. As described above, the circuits and techniques disclosed herein may be used in many apparatuses such as transmitters and receivers of a radio system. Transmitters and/or receivers intended to be included within the scope of the embodiments may include, by way of example only, WLAN transmitters and/or receivers, MIMO transmitters-receivers system, two-way radio transmitters and/or receivers, digital system transmitters and/or receivers, analog system transmitters and/or receivers, cellular radiotelephone transmitters and/or receivers, and so forth. The embodiments are not limited in this context.

Types of WLAN transmitters and/or receivers intended to be within the scope of the embodiments may include, although are not limited to, transmitters and/or receivers for transmitting and/or receiving spread spectrum signals such as, for example, Frequency Hopping Spread Spectrum (FHSS), Direct Sequence Spread Spectrum (DSSS) orthogonal frequency division multiplexing (OFDM) transmitters and/or receivers, and so forth. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a media access controller to receive a physical layer convergence procedure protocol data unit, said media access controller to output a receiver control signal in response to said data unit; and
a transceiver array to connect to said media access controller, said transceiver array having multiple receivers, with said transceiver array to switch between a first operating mode and a second operating mode in response to said receiver control signal, said first operating mode to include enabling said multiple receivers.

2. The apparatus of claim 1, wherein said first operating mode comprises one of a single-input multiple-output operating mode and a multiple-input multiple-output operating mode.

3. The apparatus of claim 1, wherein said second operating mode comprises one of a single-input single-output operating mode and a multiple-input single-output operating mode.

4. The apparatus of claim 1, further comprising a switch to connect between said media access controller and said transceiver array.

5. The apparatus of claim 1, wherein said data unit includes one or more transition symbols.

6. The apparatus of claim 5, wherein said transition symbols are used to set an automatic gain control for a receiver.

7. The apparatus of claim 1, wherein said data unit includes a physical layer address.

8. The apparatus of claim 1, wherein said data unit includes a data frame transmission period and a physical layer address.

9. The apparatus of claim 1, wherein said data unit includes a sequence of special symbols.

10. The apparatus of claim 1, wherein said data unit includes a sequence of special symbols communicated before a legacy short training sequence field having a legacy short preamble.

11. An apparatus, comprising:
a processor, said processor to send a physical layer convergence procedure protocol data unit, said data unit to cause a station to switch between a first operating mode and a second operating mode in response to said receiver control signal, said first operating mode to include enabling multiple receivers.

12. The apparatus of claim 1, wherein said first operating mode comprises one of a single-input multiple-output operating mode and a multiple-input multiple-output operating mode.

13. The apparatus of claim 11, wherein said second operating mode comprises one of a single-input single-output operating mode and a multiple-input single-output operating mode.

14. The apparatus of claim 11, wherein said data unit includes one or more transition symbols.

15. The apparatus of claim 11, wherein said data unit includes a physical layer address.

16. The apparatus of claim 11, wherein said data unit includes a data frame transmission period and a physical layer address.

17. The apparatus of claim 11, wherein said data unit includes a sequence of special symbols.

18. The apparatus of claim 11, wherein said data unit includes a sequence of special symbols communicated before a legacy short training sequence field having a legacy short preamble.

19. A system, comprising:
an access point to send a physical layer convergence procedure protocol data unit;
a first station to receive said physical layer convergence procedure protocol data unit, said station comprising:
a media access controller to output a receiver control signal in response to said data unit; and
a transceiver array to connect to said media access controller, said transceiver array to include multiple receivers and multiple antennas, with said transceiver array to switch between a first operating mode and a second operating mode in response to said receiver control signal, said first operating mode to include enabling said multiple receivers.

20. The system of claim 19, wherein said first operating mode comprises one of a single-input multiple-output operating mode and a multiple-input multiple-output operating mode.

21. The system of claim 19, wherein said second operating mode comprises one of a single-input single-output operating mode and a multiple-input single-output operating mode.

22. The system of claim 19, further comprising a switch to connect between said media access controller and said transceiver array.

23. The system of claim 19, wherein said data unit includes one or more transition symbols.

24. The system of claim 19, wherein said data unit includes a physical layer address.

25. The system of claim 19, wherein said data unit includes a data frame transmission period and a physical layer address.

26. The system of claim 19, wherein said data unit includes a sequence of special symbols.

27. The system of claim 19, wherein said data unit includes a sequence of special symbols communicated before a legacy short training sequence field having a legacy short preamble.

28. The system of claim 19, further comprising a second station, said second station to include a single transmitter, a single receiver, and a single antenna, said second station to receive said data unit and to delay contending for a wireless shared media in response to said data unit.

29. A method, comprising:
transmitting a physical layer convergence procedure protocol data unit, said data unit to cause a station to switch between a first operating mode and a second operating mode in response to said data unit, said first operating mode to include enabling multiple receivers.

30. The method of claim 29, wherein said transmitting comprises transmitting said data unit in a single-input single-output operating mode.

31. The method of claim 29, wherein said transmitting comprises transmitting said data unit in a multiple-input single-output operating mode.

32. A method, comprising:
receiving a physical layer convergence procedure protocol data unit; and
switching between a first operating mode and a second operating mode in response to said data unit, said first operating mode to include enabling a determined number of said receivers.

33. The method of claim 32, wherein said first operating mode comprises one of a single-input multiple-output operating mode and a multiple-input multiple-output operating mode.

34. The method of claim 32, wherein said second operating mode comprises one of a single-input single-output operating mode and a multiple-input single-output operating mode.

35. The method of claim 32, wherein said data unit includes one or more transition symbols.

36. The method of claim 35, further comprising:
determining an average receive power level from said transition symbols; and
setting an automatic gain control for a receiver using said average receive power level.

37. The method of claim 32, wherein said data unit includes a physical layer address.

38. The method of claim 32, wherein said data unit includes a data frame transmission period and a physical layer address.

39. The method of claim 32, wherein said data unit includes a sequence of special symbols.

40. An article, comprising:
a storage medium;
said storage medium including stored instructions that, when executed by a processor, are operable to transmit a physical layer convergence procedure protocol data unit, said data unit to cause a station to switch between a first operating mode and a second operating mode in response to said data unit, said first operating mode to include enabling multiple receivers.

41. The article of claim 40, wherein said transmitting comprises transmitting said data unit in a single-input single-output operating mode.

42. The article of claim 40, wherein said transmitting comprises transmitting said data unit in a multiple-input single-output operating mode.

43. An article, comprising:
a storage medium;
said storage medium including stored instructions that, when executed by a processor, are operable to receive a physical layer convergence procedure protocol data unit, and switch between a first operating mode and a second operating mode in response to said data unit, said first operating mode to include enabling multiple receivers.

44. The article of claim 43, wherein said first operating mode comprises one of a single-input multiple-output operating mode and a multiple-input multiple-output operating mode.

45. The article of claim 43, wherein said second operating mode comprises one of a single-input single-output operating mode and a multiple-input single-output operating mode.

46. The article of claim 43, wherein said data unit includes one or more transition symbols.

47. The article of claim 43, wherein said data unit includes a physical layer address.

48. The article of claim 43, wherein said data unit includes a data frame transmission period and a physical layer address.

49. The article of claim 43, wherein said data unit includes a sequence of special symbols.
